(19) United States
(12) Patent Application Publication
(10) Pub. No.: US 2025/0390518 A1
(43) Pub. Date: Dec. 25, 2025

(54) EVALUATING CONTEXT-SPECIFIC CONTENT GENERATED BY A GENERATIVE ARTIFICIAL INTELLIGENCE MODEL

(71) Applicant: INTUIT INC., Mountain View, CA (US)

(72) Inventors: Anant SAXENA, San Diego, CA (US); Rohan Karthik ADGALA, San Diego, CA (US); Ishani DOSHI, San Diego, CA (US); Aritra BANDYOPADHYAY, San Francisco, CA (US); Jain RYU, San Diego, CA (US)

(21) Appl. No.: 18/752,964

(22) Filed: Jun. 25, 2024

(51) Int. Cl. G06F 16/332; G06F 21/62

(52) U.S. Cl. CPC G06F 16/3329; G06F 21/6254

(57) ABSTRACT

A method for evaluating context-specific content generated by a generative artificial intelligence model includes obtaining user data that is specific to a user of a software application, the user data indicative of a contextual situation of the user. The method further includes providing an initial prompt to the generative artificial intelligence model based on the user data with the initial prompt instructing the generative artificial intelligence model to automatically generate initial content that is specific to the contextual situation of the user. The method includes obtaining the initial content from the generative artificial intelligence model. The method includes generating feedback data on the initial content according to one or more quality metrics; and performing one or more actions based on the feedback data.

### INTRODUCTION

Aspects of the present disclosure relate to generative artificial intelligence models. More specifically, the present disclosure relates to techniques for evaluating context-specific content generated by a generative artificial intelligence model for a given contextual situation.

### BACKGROUND

Every year millions of people, businesses, and organizations around the world utilize software applications to assist with countless aspects of life. For example, a software application may assist individuals with preparation of a document, such as a financial document, based on a contextual situation for a given individual. Furthermore, to provide individuals additional context regarding their contextual situation, the software application may use a generative artificial intelligence model to automatically generate content (e.g., natural language text) that is uniquely tailored to a given individual's contextual situation. For instance, the generative artificial intelligence model may generate an explanation for why the software application determined a particular result (e.g., credit) for a given individual given the individual's contextual situation.

The generative artificial intelligence model may be asked to generate context-specific content for a large number (e.g., in the thousands) of unique contextual situations. Given the large number of unique contextual situations, evaluating the quality (e.g., accuracy, relevance) of the context-specific content may be difficult since it is not feasible to manually document every possible contextual situation the generative artificial intelligence model may encounter, and because there is not currently an effective technique for automatically evaluating the quality of such content (e.g., due to technical challenges associated with quantifying the quality of such content in a manner that allows for automated evaluation).

Accordingly, techniques are needed for evaluating the quality of the context-specific content automatically generated by the generative artificial intelligence model for a given contextual situation.

### BRIEF SUMMARY

Certain embodiments provide a method for evaluating context-specific content generated by a generative artificial intelligence model. The method generally includes: obtaining user data that is specific to a user of a software application, the user data indicative of a contextual situation of the user; providing an initial prompt to the generative artificial intelligence model based on the user data, the initial prompt instructing the generative artificial intelligence model to automatically generate initial content that is specific to the contextual situation of the user; obtaining the initial content from the generative artificial intelligence model; generating feedback data on the initial content according to one or more quality metrics; and performing one or more actions based on the feedback data.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a computing environment for evaluating context-specific content generated by a generative artificial intelligence model according to some aspects of the present disclosure.

FIGS. 2A and 2B depict a sequence diagram of a technique for evaluating context-specific content generated by a generative artificial intelligence model according to some aspects of the present disclosure.

FIG. 3 depicts a user interface displaying feedback data provided by a domain expert for context-specific content generated by a generative artificial intelligence model according to some embodiments of the present disclosure.

FIG. 4 depicts a flow diagram of operations for evaluating context-specific content generated by a generative artificial intelligence model according to some aspects of the present disclosure.

FIGS. 5A and 5B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for evaluating context-specific content generated by a generative artificial intelligence model.

Example aspects of the present disclosure are directed to software applications that are utilized to prepare documents for individuals (e.g., in the millions) based on contextual situations that vary amongst the individuals. For example, such software applications may be used to prepare documents (e.g., tax returns) and may use a generative artificial intelligence model to automatically generate an explanation for a particular result determined by the software applications for a given contextual situation. For example, the particular result may be a tax refund, and the explanation may include natural language text explaining why the tax refund is applicable for the given tax situation. In this manner, by using the generative artificial intelligence, tax preparation software applications may provide additional context and confidence to users regarding their tax situation.

Example aspects of the present disclosure are directed to techniques for evaluating content the generative artificial intelligence model automatically generates to explain the particular result determined by the software application. For instance, the disclosed techniques may include generating a test account including test data that is descriptive of a given user's contextual situation and may further include prompting the generative artificial intelligence model to automatically generate content (e.g., natural language explanations for applicability of certain content) that is tailored to the given user's contextual situation. The disclosed techniques further include evaluating the automatically generated content according to one or more quality metrics (e.g., accuracy, relevance). The automatically generated content may be manually evaluated (e.g., by an expert) or automatically evaluated (e.g., by another generative artificial intelligence model) and may be labeled (e.g., manually or automatically) to generate feedback data (e.g., training data) for training, re-training, and/or otherwise dynamically updating the content generation process to improve the quality of content generated by the generative artificial intelligence model for the given contextual situation or a similar situation. For example, the training or re-training may include modifying one or more attributes of the prompt for the generative artificial intelligence model to improve the quality (e.g., accuracy, relevance) of the content the generative artificial intelligence model automatically generates for other users having the same contextual situation or a similar contextual situation.

Example aspects of the present disclosure provide numerous technical effects and benefits. For example, by utilizing a dynamic pipeline that routes particular context-specific content generated by a generative artificial intelligence model to a network of domain experts for targeted review through an efficient, guided process, the disclosed techniques allow the particular context-specific content to be evaluated for quality and further allow for training or re-training for an iteratively improving automated content generation process without first having to generate labeled training data accounting for every possible situation in a given domain which, as discussed above, is not feasible and even if feasible would result in an inefficient utilization of computing resources. Furthermore, by training or re-training an automated content generation process based on feedback data for context-specific content automatically generated for one context, techniques described herein may improve quality of context-specific content the generative artificial intelligence model generates for other contexts due to cross-context applicability of quality-related feedback. Certain embodiments provide improved user interfaces that display dynamically generated context-specific content to experts for efficient review and input of feedback through an automatically guided process, such as selecting particular content for display (e.g., based on confidence and/or relevance to a particular expert) and/or prompting experts for particular types of feedback relevant to improving an automated content generation process, thereby making optimal use of screen space and computing resources to obtain relevant feedback for process improvement. Furthermore, techniques described herein overcome the technical challenge of quantifying the quality of automatically-generated content in a manner that enables iterative improvement in quality of an automated content generation process through a guided technique that targets automatically generated content to experts and automatically prompts the experts for particular types of quality-related feedback (e.g., which of multiple content items is the most accurate, an accuracy level of such a content item, a reason for any inaccuracy of such a content item) that are uniquely useful for improvement of an automated content generation process.

### Example System for Evaluating Context-Specific Content Generated by a Generative Artificial Intelligence Model

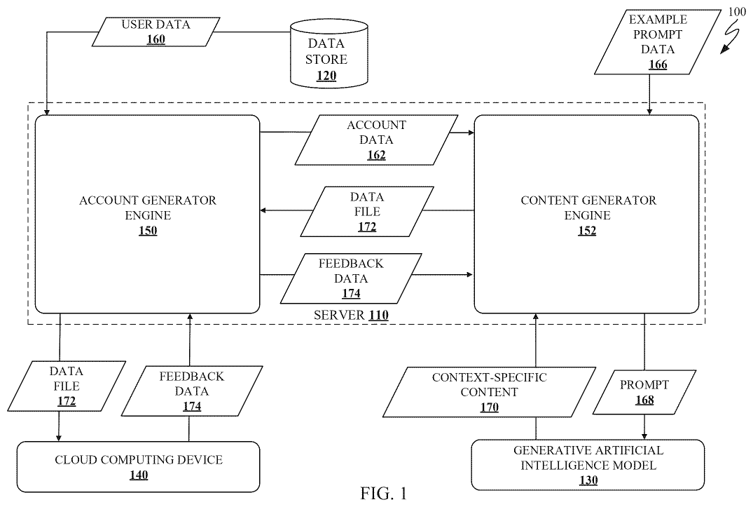

FIG. 1 depicts a pipeline 100 for evaluating context-specific content generated by a generative artificial intelligence model according to some embodiments of the present disclosure. The pipeline 100 includes a server 110, a data store 120, a generative artificial intelligence model 130, and a cloud computing device 140 in communication with one another via one or more networks (not shown). The network(s) may include, without limitation, a wide area network (WAN), a local area network (LAN), and/or a cellular network, and more generally may include any wired or wireless connection over which data may be communicated.

In some embodiments, the server 110 may include an account generator engine 150 and a content generator engine 152. The account generator engine 150 and the content generator engine 152 may include hardware, software, or a combination of hardware and software. The account generator engine 150 may be configured to obtain user data 160 stored on the data store 120. In some embodiments, the user data 160 may be associated with a user account of a software application, such as a software application for preparing a financial document (e.g., tax return). Furthermore, in such embodiments, the user data 160 may include data indicative of a contextual situation of the user associated with the user account. As an example, the data indicative of the contextual situation of the user may include financial information (e.g., home ownership, employment, etc.) the software application utilizes to prepare the financial document for the user. It is noted that while certain embodiments involving financial documents, tax situations, and the like as described herein, the scope of the present disclosure is not limited to such documents and contexts, and therefore may be implemented with other types of content and/or in other contexts. For example, discussion of examples involving a tax situation may also be applicable to examples involving other contextual situations relating to other domains, such as accounting situations, content consumption situations, social interaction situations, and/or the like.

The account generator engine 150 may be configured to generate a test account based on the user data 160. For example, in some embodiments, the account generator engine 150 may be configured to modify the user data 160 to remove or anonymize personally identifiable information (PII) sometimes alternatively referred to as “personal data”, “personal information”, or “sensitive personal information” (“SPI”). As used herein, PII may refer to information that relates to an identified or identifiable individual, which can be used on its own or with other information to identify, contact, or locate a single person, or to identify an individual in context. In some cases, different pieces of information, which collected together can lead to the identification of a particular person, also constitute PII. PII includes things such as: a name and surname; a home address; an email address; an identification card number; a tax filing ID; a date of birth, an email address, and others.

In some embodiments, the account generator engine 150 may be configured to store test account data 162 on the data store 120. In alternative embodiments, the account generator engine 150 may be configured to store the test account data 162 at another suitable location, such as locally on the server 110. The test account data 162 may include credentials (e.g., username, password, unique identifier) for the test account generated by the account generator engine 150. The test account data 162 may also include metadata indicative of a scope of a task the generative artificial intelligence model 130 is to perform with respect to the test account. For example, the metadata may include, without limitation, a topic for content the generative artificial intelligence model 130 is to generate based on the test account. Alternatively, or additionally, the metadata may indicate a number of questions to ask the generative artificial intelligence model 130 with respect to the topic.

In some embodiments, the test account data 162 may include information about the user's contextual situation. For instance, the test account data 162 may include information about the user that is associated with completion of a financial document for the user. Examples of such information may include, without limitation, marital status, employment, property ownership, or any other suitable detail that may be associated with completing a tax return.

The content generate engine may be configured to obtain the test account data 162 and example prompt data 166. Example prompt data 166 may include, without limitation, user questions, forms, instructions for said forms, field descriptions, a prompt template, and examples of different contextual situations. The user questions may include a list of common questions users may have within a given domain. The forms may include forms that are commonly used within the given domain. The instructions may include common instructions associated with each of the forms. The field descriptions may include a description for one or more data fields included in one or more of the forms. The prompt template may include information regarding how a prompt the content generator engine 152 generates for the generative artificial intelligence model 130 should be formatted. Finally, the examples may include examples of different contextual situations, such as the most common contextual situations or, in some embodiments, less common contextual situations.

The content generator engine 152 may generate a prompt 168 for the generative artificial intelligence model 130 based, at least in part, on the test account data 162 and the example prompt data 166. In some embodiments, the prompt 168 for the generative artificial intelligence model 130 may be formatted according to the prompt template included in the example prompt data 166. The generative artificial intelligence model 130 may be configured to automatically generate context-specific content 170 based on the prompt 168 provided by the content generator engine 152.

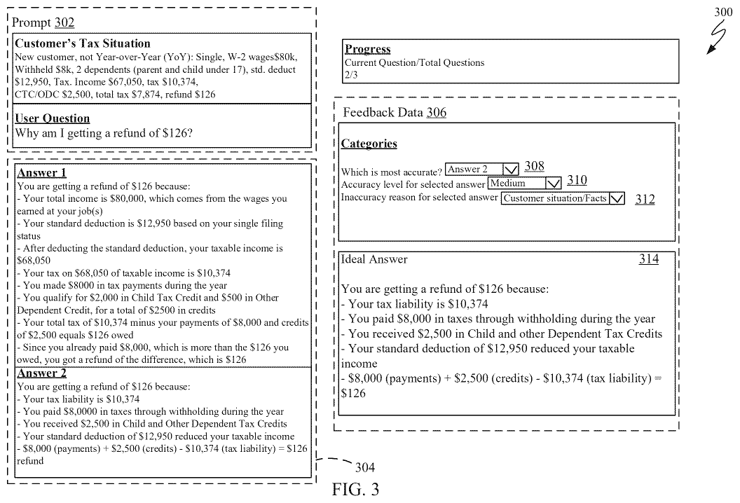

In some embodiments, the context-specific content 170 may include a plurality of answers. For instance, as discussed later on with reference to FIG. 3, the generative artificial intelligence model 130 may automatically generate a plurality of answers to a common user question (e.g., Why is my refund X amount of dollars?) within a given domain. In alternative embodiments, the context-specific content 170 automatically generated by the generative artificial intelligence model 130 may additionally include one or more questions generated by the generative artificial intelligence model 130 based, at least in part, on the prompt 168. For example, the generative artificial intelligence model 130 may be configured to generate one or more questions that the user having the contextual situation associated with the test account may have. Furthermore, the generative artificial intelligence model 130 may be configured to generate one or more answers to the one or more questions automatically generated by the generative artificial intelligence model 130.

The content generator engine 152 may be configured to generate a data file 172 based on the test account data 162, the example prompt data 166, and the context-specific content 170. For example, the data file 172 may include contextual information associated with the user of the test account. The data file 172 may also include at least a portion of the example prompt data 166. For example, in some embodiments, the data file 172 may include the list of common questions included in the example prompt data 166. The data file 172, in some embodiments, may also include information associated with one or more domain-specific documents included in the example prompt data 166. The data file 172 may also include the context-specific content 170 the generative artificial intelligence model 130 automatically generated based on the prompt 168.

In some embodiments, the data file 172 may have a particular format. For example, the data file 172 may have a comma separated value (CSV) format. It should be appreciated, however, that the scope of the present disclosure is intended to cover embodiments in which the data file 172 has other suitable formats.

As illustrated, the content generator engine 152 may provide the data file 172 to the account generator engine 150, and the account generator engine 150 may provide the data file 172 to the cloud computing device 140. In some embodiments, the cloud computing device 140 may be configured to display (e.g., on one or more client devices connected to the cloud computing device 140 via one or more networks) a user interface as illustrated in FIG. 3 that includes the contents of the data file 172. More specifically, the user interface may display the contextual information associated with the user of the test account. The user interface may also display the context-specific content 170 the generative artificial intelligence model 130 automatically generated based on the prompt 168. For example, the user interface may display the plurality of answers the generative artificial intelligence model 130 generated for each user question included in the example prompt data 166.

In some embodiments, the user interface may be viewed by one or more experts. The expert(s) may evaluate the quality (e.g., accuracy, relevance) of the context-specific content 170 the generative artificial intelligence model 130 automatically generated based on the test account data 162. In some embodiments, the tax expert(s) may interact with the user interface to provide feedback on the quality of the context-specific content 170. In such embodiments, the expert's feedback may be provided to the content generator engine 152 as feedback data 174.

The content generator engine 152 may be configured to perform one or more actions based on the feedback data 174. For example, in some embodiments, the content generator engine 152 may be configured to modify the prompt 168 based on the feedback data. As an example, in some embodiments, modifying the prompt 168 may include removing content (e.g., attributes, instructions, few shot learning examples, and/or the like) included in the prompt 168. Alternatively, the modifying the prompt 168 may include adding content (e.g., attributes, instructions, few shot learning examples, and/or the like) that was not included in the prompt 168. In some embodiments, the prompt 168 may be automatically modified in such a manner based on the feedback data 174. In this manner, the prompt 168 may be modified based on the feedback data 174 and the modified prompt may be automatically provided to the generative artificial intelligence model 130 such that the generative artificial intelligence model 130 automatically generates updated context-specific content. It should be appreciated that this process of modifying the prompt 168 based on the feedback data 174 may be iteratively performed. For instance, in some embodiments, the process of modifying the prompt 168 may be performed iteratively until the expert has no feedback on the context-specific content generated by the generative artificial intelligence mode 130 for a given contextual situation.

In some embodiments, the one or more or actions the content generator engine 152 performs based on the feedback data 174 may include modifying the example prompt data 166 that is used to generate the prompt 168. For example, in some embodiments, the contextual situation of the user associated with the test account may not be similar to any of the example contextual situations included in the example prompt data 166. In such embodiments, the content generator engine 152 may be configured to add the contextual situation associated with the user of the test account to the pool of example contextual situations included in the example prompt data 166.

In some embodiments, the cloud computing device 140 may include an additional generative artificial intelligence model. The additional generative artificial intelligence model (or the same generative artificial intelligence model used to generate the content) may be configured to automatically evaluate the data file 172 to determine whether the context-specific content 170 generated for the given contextual situation associated with a user of the test account is accurate. In much the same manner as the expert(s) described above, such a generative artificial intelligence model may provide feedback data 174 on the data file 172 and the content generator engine 152 may perform the one or more actions discussed above based on the feedback data.

In some embodiments, the data file 172 may be evaluated manually by the expert and automatically by a generative artificial intelligence model. In this manner, the content generator engine 152 may receive feedback data 174 from two different sources, the expert and a generative artificial intelligence model, that may reduce the number of iterations needed to fine tune the prompt 168 for the contextual situation associated with the user of the test account.

In some embodiments, the additional generative artificial intelligence model trained to automatically evaluate context-specific content generated by the generative artificial intelligence model 130 may be trained through a supervised learning process based on labeled training data indicating accurate content (e.g., for particular contextual situations). For example, a supervised learning process may involve providing training inputs (e.g., content items) as inputs to the additional generative artificial intelligence model. The additional generative artificial intelligence model processes the training inputs and produces outputs (e.g., quality indicators) based on the training inputs. The outputs are compared to the labels associated with the training inputs to determine the accuracy of the model predictions, and parameters of the additional generative artificial intelligence model are iteratively adjusted until one or more conditions are met. For instance, the one or more conditions may relate to an objective function (e.g., a cost function or loss function) for optimizing one or more variables (e.g., relating to model accuracy). In some embodiments, the conditions may relate to whether the predictions produced by the model based on the training inputs match the labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. It is noted that the user action data included in the training data may include clickstream data, date and time information, user attributes, device attributes, application attributes, and/or the like. Thus, the weights output by the additional generative artificial intelligence model may be based on actions as well as other contextual information such as a user's profession, industry, length of use of the application, skill(s), the date(s) and/or time(s) associated with given activities, the type of device (e.g., smartphone, laptop, desktop, tablet, and/or the like) being used to perform activities, the type of application (e.g., web application or standalone application) being used to perform the activities, the task that the user intends to perform (e.g., which may be inferred based on other contextual data and/or action data), and/or the like.

In some embodiments, the additional generative artificial intelligence model may be configured to send the context-specific content 170 to a plurality of experts for manual review (e.g., via the user interface discussed above) based on a confidence score for the context-specific content 170 as determined by the additional generative artificial intelligence model. For example, if the confidence score determined by the additional generative artificial intelligence model is below a threshold confidence level (e.g., 90 percent), the additional generative artificial intelligence model may supplement the review of the context-specific content 170 by prompting the plurality of experts to manually review the context-specific content 170. Alternatively, if the confidence score determined by the additional generative artificial intelligence model is above the threshold confidence level (e.g., 90 percent or greater), the additional generative artificial intelligence model may automatically generate the feedback data 174, if any, to automatically adjust one or more attributes of the prompt 168 without requiring an additional level of manual review by the plurality of experts.

### Example Technique for Evaluating Context-Specific Content Generated by a Generative Artificial Intelligence Model

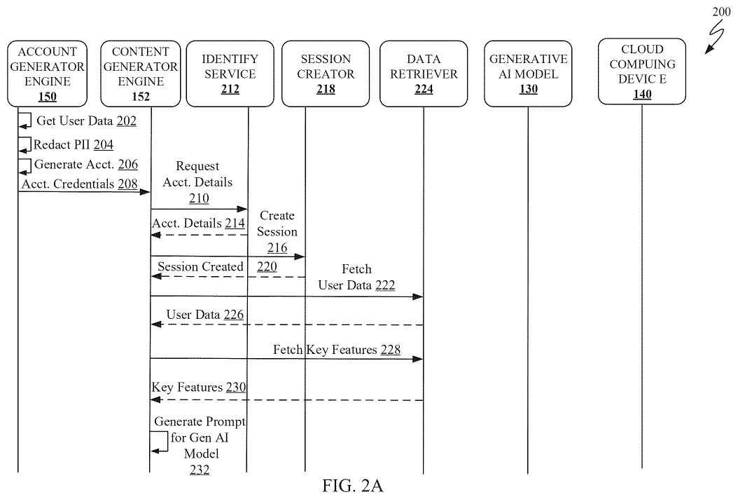

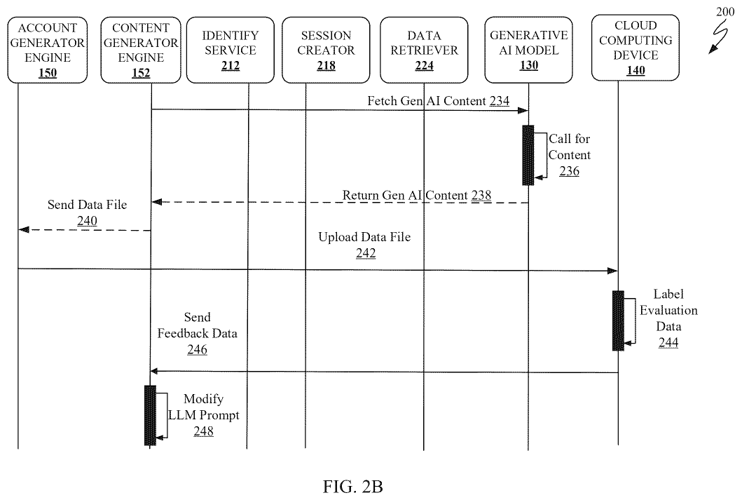

FIGS. 2A and 2B illustrate a sequence diagram 200 of a technique for evaluating context-specific content generated by a generative artificial intelligence model, according to some embodiments of the present disclosure. The technique may be implemented using the pipeline 100 discussed above with reference to FIG. 1. Details of the technique will now be discussed.

At 202, the account generator engine 150 may obtain user data. For example, the account generator engine 150 may obtain user data for a user associated with a software application, such as a financial software application for preparing financial documents (e.g., tax returns). In some embodiments, the account generator engine 150 may obtain the user data from a data store, such as the data store 120 illustrated in FIG. 1.

At 204, the account generator engine 150 may redact the PII included in the user data to generate modified user data. In some embodiments, the account generator engine 150 may store the modified user data on the data store 120.

At 206, the account generator engine 150 may generate a test account. The test account may be associated with the modified user data. Furthermore, the account generator engine 150 may be configured to generate credentials (e.g., login name, unique user identifier) that allow the test account to be accessed to obtain the modified user data.

At 208, the account generator engine 150 may provide the credentials for the test account to the content generator engine 152.

At 210, the content generator engine 152 may request account details from an identify service 212. The identify service 212 may be associated with the software application and may be configured to authenticate the content generator engine 152 by determining the credentials the content generator engine 152 provided are associated with the test account. Once the identify service 212 has authenticated the content generator engine 152, the identify service 212 may provide the account details for the test account at 214.

At 216, the content generator engine 152 may create a session based on the account details received at 214. For instance, the content generator engine 152 may send a request to a session creator 218 associated with the software application. Upon receiving the request, the session creator 218 may, at 220, create the session and send an acknowledgement to the content generator engine 152 confirming the session involving the content generator engine 152 and the test account has been created.

At 220, the content generator engine 152 may request the modified user data associated with the test account. For example, in some embodiments, the content generator engine 152 may send a request to a date retriever 224. At 226, the data retriever 224 may provide the modified user data to the content generator engine 152.

At 228, the content generator engine 152 may request (e.g., via the data retriever 224) key features associated with the test account. For example, the key features may include contextual information associated with the user of the test account. In some embodiments, the content generator engine 152 may determine whether the user associated with the test account is a new user (that is, a user that has not previously used the software application) or a returning user (that is, a year over year user). If the content generator engine 152 determines the user is a returning user, the content generator engine 152 may request the key features for test account for the current fiscal year as well as the key features for the test account for the previous year. At 230, the data retriever 224 returns the key features associated with the test account.

At 232, the content generator engine 152 may generate a prompt for the generative artificial intelligence model 130. For example, in some embodiments, the prompt may include the user data associated with the test account and may instruct the generative artificial intelligence model 130 to generate a plurality of answers to one or more user questions specific to a user having a contextual situation that is the same or similar to the contextual situation of the user associated with the test account.

At 234, the content generator engine 152 requests the generative artificial intelligence model 130 generate context-specific content based on the prompt generated at 232. At 236, the generative artificial intelligence model 130 automatically generates the context-specific content. At 238, the generative artificial intelligence model 130 returns the generated context-specific content to the content generator engine 152.

At 240, the content generator engine 152 sends a data file (e.g., CSV file) that includes the context-specific content automatically generated by the generative artificial intelligence model. The file may also include additional information, such as the modified user data and the one or more questions for which the generative artificial intelligence model 130 was asked to generate answers.

At 242, the content generator engine 152 uploads the data file to the cloud computing device 140. At 244, the context-specific content generated by the generative artificial intelligence model 130 and included in the data file is evaluated for quality (e.g., accuracy, relevance). In some embodiments, the context-specific content is evaluated manually by one or more tax experts. Alternatively, or additionally, in some embodiments, the context-specific content is evaluated automatically by another generative artificial intelligence model that is trained to evaluate the quality of the context-specific content generated by the generative artificial intelligence model 130.

At 246, feedback data that includes feedback on the context-specific content generated by the generative artificial intelligence model 130 is provided to the content generator engine 152. At 248, the content generator engine 152 may modify the prompt for the generative artificial intelligence model based, at least in part, on the feedback data received at 246. For instance, the content generator engine 152 may remove information from the prompt. Alternatively, or additionally, the content generator engine 152 may add information to the prompt.

After modifying the prompt at 248, the content generator engine 152 may again prompt the generative artificial intelligence model 130 to automatically generate context-specific content based, at least in part, on the updated prompt. Furthermore, the data file may be updated with the updated context-specific content and the updated data file may be provided to the cloud computing device 140 such that the updated context-specific content may be evaluated for quality. It should be appreciated that, in some embodiments, this process may be repeated until no feedback data is provided on the updated context-specific content that would result in further modifications to the prompt.

### Example User Interface for Evaluating Context-Specific Content Generated by a Generative Artificial Intelligence Model

FIG. 3 depicts a user interface 300 for evaluating context-specific content generated by a generative artificial intelligence model according to some embodiments of the present disclosure. As shown, the user interface 300 may display at least a portion of a prompt 302 the generative artificial intelligence model received. As illustrated, the portion of the prompt 302 displayed in the user interface 300 includes contextual information for a user and a question that the user might ask. Displaying at least a portion of prompt 302 within user interface 300 may enable an expert to better understand and evaluate the displayed context-specific content (e.g., answers) or other content.

The context-specific content generated by the generative artificial intelligence model and displayed in the user interface 300 may include a plurality of answers 304 the generative artificial intelligence model automatically generated based on the prompt 302. As illustrated, the generative artificial intelligence model generated two different sets of answers to the question included in the prompt 302. In some embodiments, answers (or other generated content) may be displayed within user interface 300 in a manner that is based on priorities associated with the answers (or other generated content). For example, answers or content items may be assigned priorities based on one or more factors such as confidence scores output by the generative artificial intelligence model in association with the answers or content items, amounts of existing labeled data associated with particular contextual situations, amounts of existing labeled data associated with high-confidence or low-confidence answers, and/or the like. For example, priorities may allow for higher-confidence or lower-confidence answers of content items or content items having particular attributes to be dynamically selected for display before other content items in order to obtain particular types of feedback efficiently. The answers may be displayed within user interface 300 in an order that is based on the priorities (e.g., displaying a highest priority answer or content item first). The answers or other content items may be displayed together (e.g., in an ordered list) or separately (e.g., one at a time) within user interface 300.

The user interface 300 also displays feedback data 306 that has been provided by a domain expert to indicate the domain expert's evaluation of the quality of the context-specific content (e.g., the plurality of answers 304) automatically generated by the generative artificial intelligence model based on the prompt 302. As illustrated, the user interface 300 may include a drop-down menu 308 that allows the domain expert to select which answer of the plurality of answers 304 generated by the generative artificial intelligence model is most accurate. The user interface 300 further includes a drop-down menu 310 that allows the tax expert to assign an accuracy level (e.g., easy, medium, hard) for the answer selected in drop-down menu 308. The user interface 300 may further include a drop-down menu 312 that allows the domain expert to provide a reason why the domain expert concluded the selected answer of the plurality of answers 304 was inaccurate (e.g., which the expert may select from a drop-down menu of configured reasons that are particularly relevant to quantifying the quality of content items for use in improving an automated content generation process). In some embodiments, the user interface 300 may include a window 314 displaying the answer the tax expert selected in drop-down menu 308 as being the selected answer to the question included in the prompt 302 provided to the generative artificial intelligence model (e.g., the generative artificial intelligence model 130 depicted in FIG. 1).

It should be understood that the user interface 300 depicted in FIG. 3 is provided for illustrative purposes and therefore the scope of the present disclosure is not intended to be limited to the user interface 300 of FIG. 3. For example, the scope of the present disclosure is intended to cover any suitable user interface that displays the relevant information (e.g., prompt and generated context-specific content) the expert needs to evaluate the quality of context-specific content generated by the generative artificial intelligence model. Furthermore, references to tax experts, tax returns, and tax situations are included as examples, and other types of experts, data, and contextual situations may be applicable to techniques described herein.

### Example Operations for Evaluating Context-Specific Content Generated by a Generative Artificial Intelligence Model

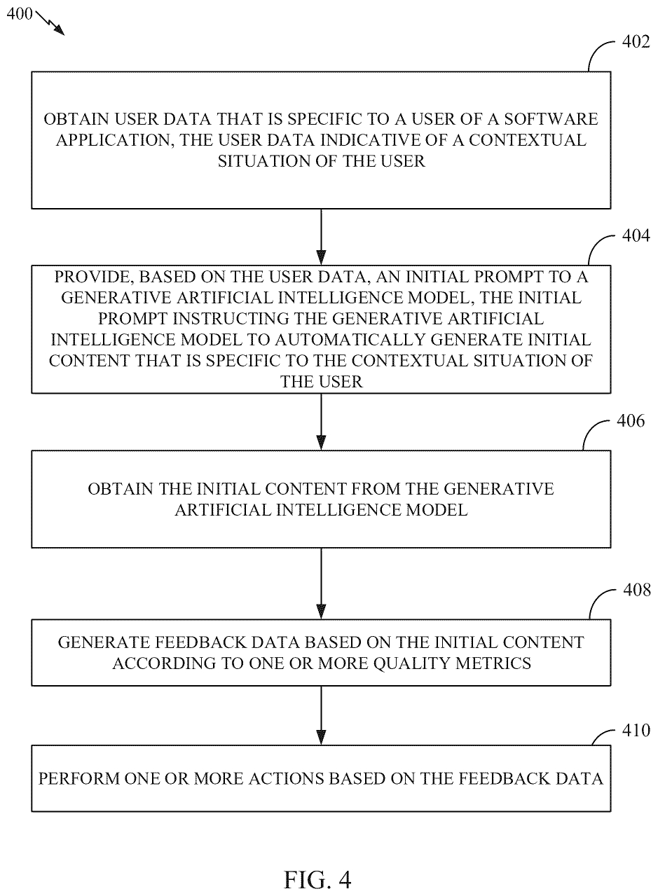

FIG. 4 is a flow diagram of example operations 400 for evaluating content generated by a generative artificial intelligence model according to some embodiments of the present disclosure. The operations 400 may be performed by instructions executing on a processor of a server (such as the server 110 of FIG. 1).

Operation 402 includes obtaining user data that is specific to a user of a software application. For example, the user data may be associated with a user account for a first-time user of the software application or a returning user (e.g., year-over-year) of the software application. The user data may be indicative of a contextual situation of the user within a given domain. For example, as discussed above, the software application may be an account software application for assisting users with preparing an accounting document (e.g., tax return), and the user data may be indicative of a tax situation that is unique to the user.

Operation 404 includes providing an initial prompt to the generative artificial intelligence model based on the user data. For instance, the initial prompt may instruct the generative artificial intelligence model to automatically generate initial content that is specific to the contextual situation of the user. As discussed above, in some embodiments, the initial prompt may include other content besides the user data. For example, in some embodiments, the prompt may include one or more questions specific to the domain associated with the software application and one or more examples of different contextual situations that may or may not be applicable to the user's contextual situation.

Operation 406 includes obtaining the initial content automatically generated by the generative artificial intelligence model. For example, in some embodiments, the initial content generated by the generative artificial intelligence model may include a plurality of answers to one or more questions included in the prompt

Operation 408 includes generating feedback data based on the initial content obtained at operation 406. For example, generating the feedback data based on the initial content automatically generated by the generative artificial intelligence model may include generating a file that includes the initial content generated by the generative artificial intelligence model and at least a portion of the user data. Generating the feedback data may further include providing a user interface displaying the initial content and the at least a portion of the initial prompt and receiving feedback data in the form of user input from a domain expert via one or more user interface elements of the user interface. Generating the feedback data further includes updating the file with the feedback data from the tax expert.

Operation 410 includes performing one or more actions based on the feedback data generated at operation 408. For example, in some embodiments, the one or more actions may include modifying the prompt provided to the generative artificial intelligence model based, at least in part, on the feedback data. For example, in some embodiments, modifying the prompt may include removing content from the prompt. Alternatively, or additionally, modifying the prompt may include adding content to the prompt that, based on the feedback data, may improve the quality of the context-specific content generated by the generative artificial intelligence model.

In certain embodiments, the operations 400 may include obtaining updated context-specific content from the generative artificial intelligence model based, at least in part, on the modified prompt. Furthermore, the operations 400 may further include generating additional feedback data on the updated context-specific content to use to re-train the generative artificial intelligence model (e.g., by further modifying the prompt) to further improve the quality of context-specific content the generative artificial intelligence model generates for a given context (e.g., tax situation).

### Example Computing System

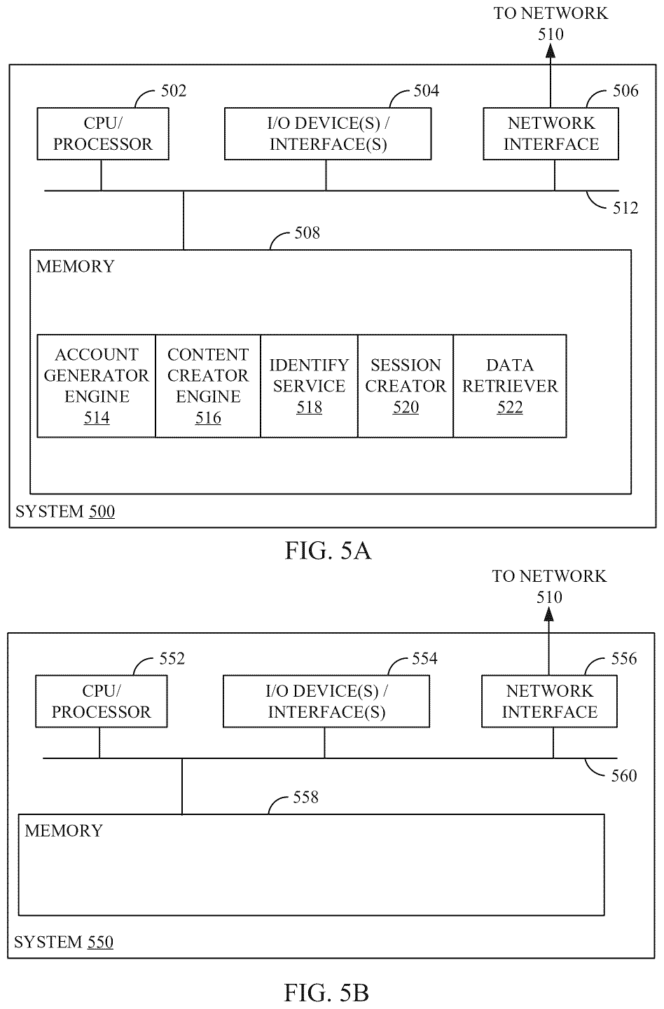

FIG. 5A illustrates an example computing system 500 with which embodiments of the disclosure related to evaluating context-specific content generated by a generative artificial intelligence model may be implemented. For example, the computing system 500 may be representative of the server 110 of FIG. 1.

The computing system 500 includes a central processing unit (CPU) 502, one or more I/O device interfaces 504 that may allow for the connection of various I/O devices 504 (e.g., keyboards, displays, mouse devices, pen input, etc.) to the computing system 500, a network interface 506, a memory 508, and an interconnect 512. It is contemplated that one or more components of the computing system 500 may be located remotely and accessed via a network 510. It is further contemplated that one or more components of the computing system 500 may include physical components or virtualized components.

The CPU 502 may retrieve and execute programming instructions stored in the memory 508. Similarly, the CPU 502 may retrieve and store application data residing in the memory 508. The interconnect 512 transmits programming instructions and application data, among the CPU 502, the I/O device interface 504, the network interface 506, the memory 508. The CPU 502 is included to be representative of a single CPU, multiple CPUs, a single CPU having multiple processing cores, and other arrangements.

Additionally, the memory 508 is included to be representative of a random access memory or the like. In some embodiments, the memory 508 may include a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, the memory 508 includes account generator engine 514, content generator engine 516, identify service 518, session creator 520, and data retriever 522, which may be representative of account generator engine 150, content generator engine 152, identify service 212, session creator 218, and data retriever 224 of FIGS. 1, 2A and 2B.

FIG. 5B illustrates an example computing system 550 with which embodiments of the disclosure related to evaluating context-specific content generated by a generative artificial intelligence model may be implemented. For example, the computing system 550 may be representative of the generative artificial intelligence model 130 and cloud computing device 140 of FIG. 1.

The computing system 550 includes a central processing unit (CPU) 552, one or more I/O device interfaces 554 that may allow for the connection of various I/O devices 554 (e.g., keyboards, displays, mouse devices, pen input, etc.) to the computing system 550, a network interface 556, a memory 558, and an interconnect 560. It is contemplated that one or more components of the computing system 550 may be located remotely and accessed via the network 510. It is further contemplated that one or more components of the computing system 550 may include physical components or virtualized components.

The CPU 562 may retrieve and execute programming instructions stored in the memory 558. Similarly, the CPU 552 may retrieve and store application data residing in the memory 558. The interconnect 560 transmits programming instructions and application data, among the CPU 552, the I/O device interface 554, the network interface 556, the memory 558. The CPU 552 is included to be representative of a single CPU, multiple CPUs, a single CPU having multiple processing cores, and other arrangements.

Additionally, the memory 558 is included to be representative of a random access memory or the like. In some embodiments, the memory 558 may include a disk drive, solid state drive, or a collection of storage devices distributed across multiple storage systems. Although shown as a single unit, the memory 558 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of evaluating context-specific content generated by a generative artificial intelligence model, comprising:
obtaining user data that is specific to a user of a software application, the user data indicative of a contextual situation of the user;
providing an initial prompt to the generative artificial intelligence model based on the user data, the initial prompt instructing the generative artificial intelligence model to automatically generate initial content that is specific to the contextual situation of the user;
obtaining the initial content from the generative artificial intelligence model;
generating feedback data on the initial content according to one or more quality metrics; and
performing one or more actions based on the feedback data.

2. The method of claim 1, wherein the one or more actions comprise:
modifying the initial prompt provided to the generative artificial intelligence model based, at least in part, on the feedback data to generate a modified prompt;
providing the modified prompt to the generative artificial intelligence model; and
obtaining updated content from the generative artificial intelligence model, the updated content being improved compared to the initial content according to the one or more quality metrics.

3. The method of claim 2, wherein modifying the initial prompt includes:
adding information to the initial prompt based on the feedback data; or
removing information from the initial prompt based on the feedback data.

4. The method of claim 1, wherein generating the feedback data comprises:
generating a file comprising at least a portion of the user data and the initial content generated by the generative artificial intelligence model;
providing a user interface displaying at least a portion of the initial prompt, the user interface further displaying the initial content generated by the generative artificial intelligence model;
receiving feedback data comprising user input with respect to the initial content from an expert via one or more user interface elements of the user interface; and
updating the file with the feedback data.

5. The method of claim 4, wherein the file comprises a comma separated value (CSV) file.

6. The method of claim 1, wherein the initial content comprises a plurality of answers generated by the generative artificial intelligence model in response to a question included in the initial prompt.

7. The method of claim 1, wherein obtaining the user data comprises:
obtaining data for the user based, at least in part, on a unique identifier for the user, the data comprising personal information about the user;
removing or anonymizing the personal information to generate anonymized data; and
generating a test account based on the anonymized data.

8. The method of claim 7, wherein providing an initial prompt to the generative artificial intelligence model comprises:
obtaining credentials associated with the test account;
accessing the test account via the credentials to establish a session associated with the test account;
in response to establishing the session, obtaining the anonymized data; and
generating the initial prompt based, at least in part, on the anonymized data.

9. The method of claim 1, wherein generating the feedback data comprises providing the initial content and at least a portion of the initial prompt to an additional generative artificial intelligence model trained to determine quality of the initial content.

10. The method of claim 1, wherein generating the feedback data comprises:
providing the initial content to an additional generative artificial intelligence model configured to evaluate the initial content;
determining whether additional evaluation of the initial content is needed based, at least in part, on a confidence score output by the additional generative artificial intelligence model and associated with the initial content.

11. The method of claim 10, wherein determining whether additional evaluation of the initial content is needed comprises:
determining whether the confidence score output by the additional generative artificial intelligence model exceeds a threshold confidence score; and
in response to determining the confidence score does not exceed the threshold confidence score, providing the initial content for additional evaluation.

12. The method of claim 11, wherein providing the initial content for additional evaluation comprises generating a user interface displaying the initial content, the user interface comprising one or more user interface elements configured to receive input from one or more experts, the input indicative of the one or more experts evaluation of the initial content.

13. A system for evaluating context-specific content generated by a generative artificial intelligence model, the system comprising:
a memory including computer executable instructions; and
a processor configured to execute the computer executable instructions and cause the system to:
obtain user data that is specific to a user of a software application, the user data indicative of a contextual situation of the user;
provide an initial prompt to the generative artificial intelligence model based on the user data, the initial prompt instructing the generative artificial intelligence model to automatically generate initial content that is specific to the contextual situation of the user;
obtain the initial content from the generative artificial intelligence model;
generating feedback data on the initial content according to one or more quality metrics; and
perform one or more actions based on the feedback data.

14. The system of claim 13, wherein the one or more actions comprise:
modifying the initial prompt provided to the generative artificial intelligence model based, at least in part, on the feedback data to generate a modified prompt;
providing the modified prompt to the generative artificial intelligence model; and
obtaining updated content from the generative artificial intelligence model, the updated content being improved compared to the initial content according to the one or more quality metrics.

15. The system of claim 13, wherein to generate the feedback data, the computer executable instructions cause the system to:
generate a file comprising at least a portion of the user data and the initial content generated by the generative artificial intelligence model;
provide a user interface displaying at least a portion of the initial prompt, the user interface further displaying the initial content generated by the generative artificial intelligence model;
receive feedback data comprising user input with respect to the initial content from an expert via one or more user interface elements of the user interface; and
update the file with the feedback data.

16. The system of claim 13, wherein the initial content comprises a plurality of answers generated by the generative artificial intelligence model in response to a question included in the initial prompt.

17. The system of claim 13, wherein to generate the feedback data, the computer executable instructions cause the system to:
provide the initial content to an additional generative artificial intelligence model configured to evaluate the initial content;
determine whether additional evaluation of the initial content is needed based, at least in part, on a confidence score output by the additional generative artificial intelligence model and associated with the initial content.

18. The system of claim 17, wherein to determine whether additional evaluation of the initial content is needed, the computer executable instructions cause the system to:
determine whether the confidence score output by the additional generative artificial intelligence model exceeds a threshold confidence score; and
in response to determining the confidence score does not exceed the threshold confidence score, provide the initial content for additional evaluation.

19. The system of claim 18, wherein to provide the initial content for additional evaluation, the computer executable instructions cause the system to:
generate a user interface displaying the initial content, the user interface comprising one or more user interface elements configured to receive input from one or more experts, the input indicative of the one or more experts evaluation of the initial content.

20. A non-transitory computer-readable medium comprising instructions to be executed in a computer system to evaluate context-specific content generated by a generative artificial intelligence model, wherein the instructions when executed in the computer system cause the computer system to:
obtain user data that is specific to a user of a software application, the user data indicative of a contextual situation of the user;
provide an initial prompt to the generative artificial intelligence model based on the user data, the initial prompt instructing the generative artificial intelligence model to automatically generate initial content that is specific to the contextual situation of the user;
obtain the initial content from the generative artificial intelligence model;
generating feedback data on the initial content according to one or more quality metrics; and
perform one or more actions based on the feedback data
